(19) United States
(12) Patent Application Publication
(10) Pub. No.: US 2009/0059998 A1
(43) Pub. Date: Mar. 5, 2009

(54) Multiple temperature resistance characteristic sensing cable and its sensor

(76) Inventor: Billy Hou, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,681

(22) Filed: Aug. 27, 2007

(51) Int. Cl. G01K 7/16

(52) U.S. Cl. 374/185; 374/170; 374/E07.018

(57) ABSTRACT

A multiple temperature resistance characteristic sensing cable comprised of 1˜6 metal conductors with restorable insulation layer. Each cable contains different temperature resistance characteristic, and is wrapped by 1-2 layers of outer sheath. The metal conductors are wrapped by 1-2 insulation layers and twisted together. These twisted wires are inside the 1-2 layers of outer sheath. The temperature sensor comprises an interface unit, a sensing cable corresponding to temperature resistance characteristics, and a cable terminal unit. The interface unit comprises a signal amplifier and linear circuit, an A/D converter, a microprocessor, a display and operation circuit, a pulse output circuit, and a timer circuit. The temperature sensor realizes the differential temperature, fixed temperature or differential fixed temperature alarm among low, mid and high temperature sections.

### BACKGROUND OF THE INVENTION

1. Field of the Invention

The present invention relates to the design of a sensing cable, which involves a positioning type linear heat detector that consists of sensing cables.

2. Description of the Related Art

The linear heat detectors has been developed and intensively used since 70s of last century. Comparing to the point type linear heat detector, the linear type heat detector takes the advantage of the capability of continuous monitoring along with the line area, and the endurance to adverse circumstances. The developing of the linear type temperature sensing detector has experienced many stages. From the digital type to analog type, then to continuous heat thermal coupler detector, and to distributed fiber optical system developed in recent decades. Naturally, each type has its merits and drawbacks.

The recently developed continuous temperature measurement and positioning detector and distributed fiber optical temperature measurement system are the more advanced systems. Within the detector's resolution range (basic heated length), it can accurately show the temperature and generate alarm. The longer the heated length, the more accurate the temperature measurement, and the more accurate the alarm report. The drawback of the distributed fiber optical temperature measurement system is the risk on the controller's lifetime and too many fire prevention sections on a single circuit. Besides, for the heating on a short length, say, less than 1 meter, the temperature measurement is not accurate such that alarm report might not correct. For the continuous temperature measurement and positioning detector, the drawback is the same: reaction is not sensitive enough to a short length heating. The drawback is just the merit of the analog and digital linear heat detectors as they respond and generate alarm even if heated within a very short length.

### SUMMARY OF THE INVENTION

The present invention has been accomplished under the circumstances in view. It is the main object of the present invention to provide a sensing cable with multiple temperature resistance characteristics, which is cost-saving and repeatedly re-usable, having a very high anti-error report capability and a very high detection sensitivity. It is another object of the present invention to provide a temperature sensing detector for use on the sensing cable, which offers the features of signal processing, temperature differentiation and fixed temperature alarm report, abnormal temperature point positioning, and alarm display.

Comparing to prior art designs, the invention has the following advantages:

1. It is capable of reacting to very short length detector heating, and fully restorable. It won't cause qualitative changing due to internal or external influences.

2. It is capable of making temperature characteristic combination at user's own choice to meet the requirements at different environments. For instance, if it is required to get good temperature characteristic at above a certain threshold temperature Tm, the combination of PTC and NTC insulation layers can be chosen.

3. It has a very high anti-error report capability. When chosen highest environment temperature is greater than threshold temperature changing point Tm, the changing of environment temperature and heating length will not cause an error report.

4. It contains abnormal temperature point positioning feature.

### BRIEF DESCRIPTION OF THE DRAWINGS

FIG. 1 is a block diagram of a temperature sensing detector in accordance with the present invention.

FIG. 2A is a schematic drawing showing the structure of a temperature sensing cable in accordance with a first embodiment of the present invention.

FIG. 2B is a sectional view of the temperature sensing cable according to the first embodiment of the present invention, showing the wires twisted.

FIG. 2C is a sectional view of the temperature sensing cable according to the first embodiment of the present invention, showing the wires arranged in parallel.

FIGS. 2D˜2G are synthesized characteristic changing curves of the combination of 2 kinds of different temperature resistance characteristics according to the first embodiment of the present invention.

FIG. 3A is a schematic drawing showing the structure of a temperature sensing cable in accordance with a second embodiment of the present invention.

FIG. 3B is a sectional view of the temperature sensing cable of FIG. 3A.

FIGS. 3C˜3F are synthesized characteristic changing curves of the combination of 2 kinds of different temperature resistance characteristics according to the second embodiment of the present invention.

FIG. 4A is a schematic drawing showing the structure of a temperature sensing cable in accordance with a third embodiment of the present invention.

FIG. 4B is a sectional view of the temperature sensing cable of FIG. 4A.

FIG. 5A is a schematic drawing showing the structure of a temperature sensing cable in accordance with a fourth embodiment of the present invention.

FIG. 5B is a sectional view of the temperature sensing cable according to the fourth embodiment of the present invention, showing the wires twisted.

FIG. 5C is a sectional view of the temperature sensing cable according to the fourth embodiment of the present invention, showing the wires arranged in parallel.

FIGS. 5D˜5G are synthesized characteristic changing curves of the combination of 3 kinds of different temperature resistance characteristics according to the fourth embodiment of the present invention.

### DETAILED DESCRIPTION OF THE PREFERRED EMBODIMENT

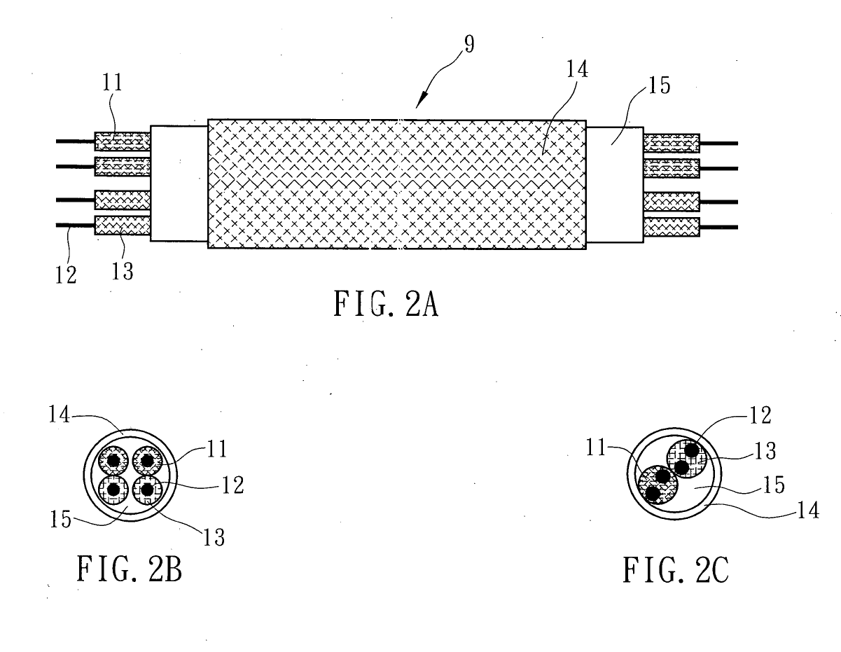

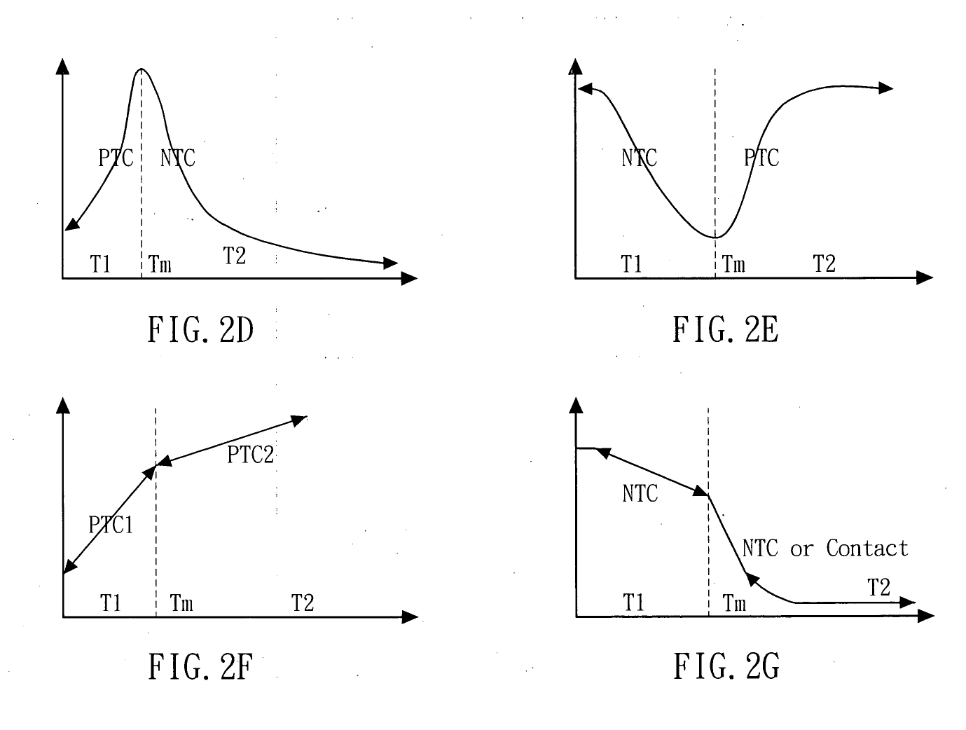

Referring to FIG. 2A, a sensing cable 9 in accordance with a first embodiment of the present invention is shown comprised of 4 metal conductors 12. Two by two are wrapped with different temperature resistance characteristic thermal sensitive material insulation layer 11, 13. The wires are twisted (as shown in FIG. 2B) or arranged in parallel (as shown in FIG. 2C), and then wrapped with 1-2 layers of outer sheath 14, 15. The metal conductors can be copper wires, stainless wires, thermal coupler wires, alloy resistance wires, other metal conductors, or a combination of different conductor materials. The thermal sensitive material can be NTC (Negative Temperature Coefficient), PTC (Positive Temperature Coefficient), or other non-solvable “tunnel conduction effect” restorable materials, or solvable materials. The purposes of the design are: 1. To ensure to obtain the characteristic parameters of the sectional temperature range, and not to get loss the characteristic in any section when needed. This is to guarantee the production of the multiple alarm stages temperature sensing detector which is capable of low temperature alarm and differential temperature alarm (usually below 54° C., and is capable of effectively adapt to environment temperature changing with high reliability as well. 2. For the sensitive sections, the threshold temperature changing Tm and temperature range ΔT1, ΔT2 can be detected through the integrate effect of thermal characteristic such that to avoid from error report in the unexpected temperature range. For example, the detector can be made to generate fixed temperature alarm when it is greater than Tm so that the reliability can be promoted greatly.

The key components of the NTC thermal sensing material include: high-density polyethylene, or EVA (Ethylene Vinyl Acetate), conduction additive, anti-oxidant and other additives. The key components of the PTC thermal sensing material include (calculated as per 100% weight): 30˜60% PVDF polymer or copolymer, 10˜60% conduction additive, 0-30% crystal or semi-crystal polymer, 0-30% of other additives. The key components of the non-solvable “tunnel conductor effect” restorable thermal sensing material include (calculated as per 100% weight): Program 1:40˜60% of high-density polyethylene, 10˜30% of EVA, 10˜25% of carbon black, 10˜30% of zinc oxide. Program 2: 50˜80% of ETFE (Ethylene-tetrafluoroethylene), 0˜24% of vinylidene fluoride hexafluoro-propene, 0˜15% of carbon black, 10˜20% of zinc oxide. Solvable material mainly includes EVA, LDPE (Low Density Polyethylene), HDPE (High Density Polyethylene), or solvable salt.

Referring to FIG. 2A, the equivalent resistance of the sensing cable 9 R_{eq}=R_{thermal sensitive material 1}//R_{thermal sensitive material 2}// . . . //R_{thermal sensitive material n}. As shown in FIG. 2D, it can be selected that below Tm temperature the NTC material resistance is higher and change smaller, and above Tm temperature the resistance is becoming smaller, below Tm temperature the PTC materials resistance is lower and change rapidly, and Tm temperature the resistance is larger and change smaller, such that to form a temperature characteristic sensing cable. The performance of temperature resistance characteristic of such a sensing cable is that below Tm it is negative temperature coefficient changing property. Such a detector can realize the differential temperature alarm below Tm, and realize the fixed temperature alarm above Tm as well. So, the detector will not lose any information, and in the same time it guarantees to generate alarm only when the temperature is above Tm.

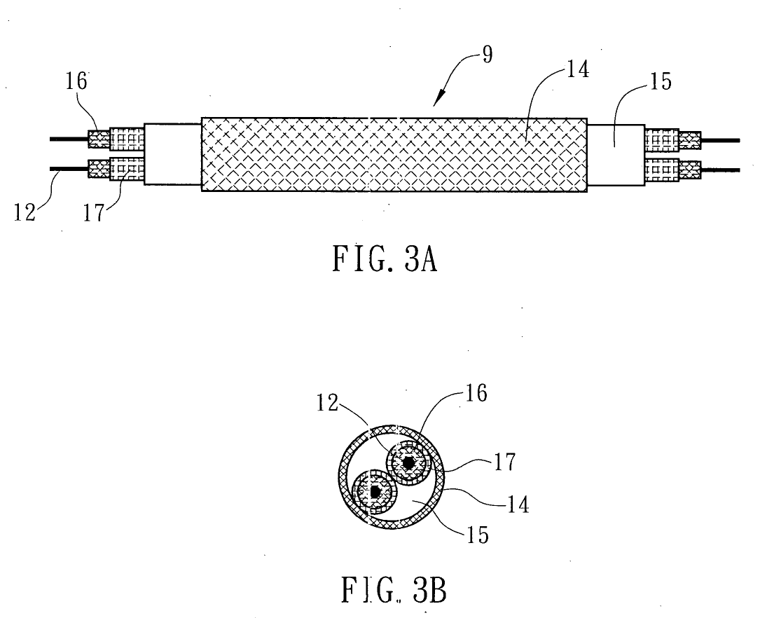

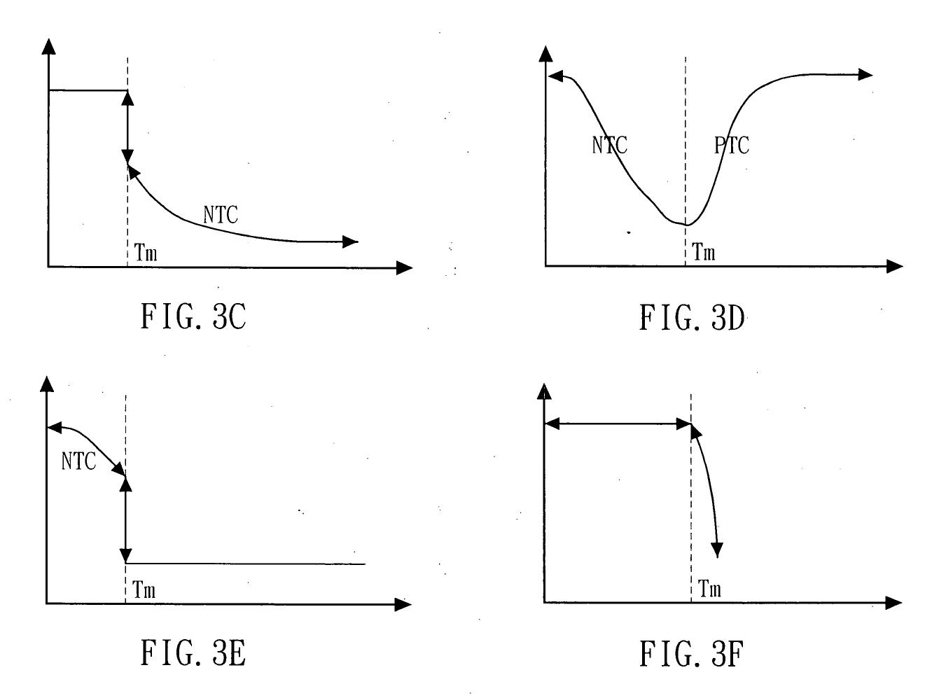

Referring to FIG. 3A, a sensing cable 9 in accordance with a second embodiment of the present invention is shown comprised of 2 metal conductors 12. Each conductor is wrapped with different temperature resistance characteristic thermal sensitive material insulation layers 16, 17. The wires are twisted or arranged in parallel, and then wrapped with 1˜2 layers of outer sheath 14, 15. The difference to FIG. 2A is that the higher resistance layer decides the synthesized resistance characteristic. The synthesized resistance will show change or sudden change at Tm.

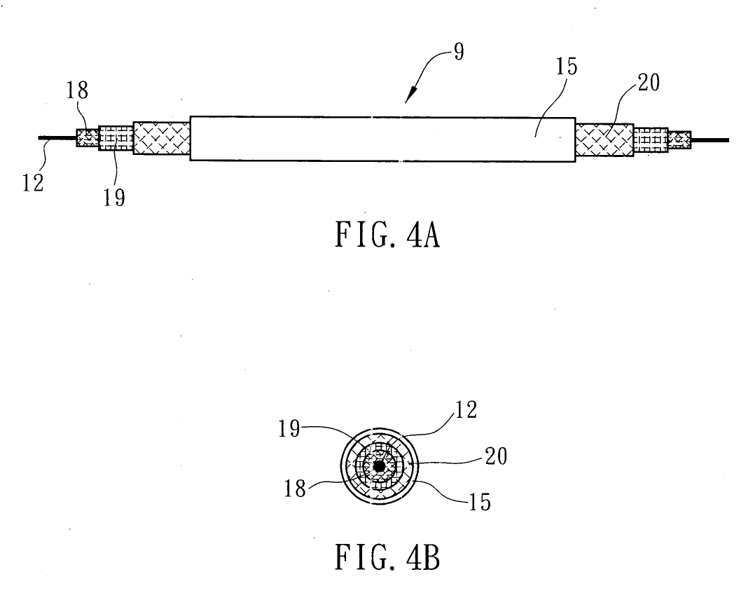

Referring to FIG. 4A, a sensing cable 9 in accordance with a third embodiment of the present invention is shown made of 1 metal conductor 12 with which wrapped with different temperature resistance characteristic thermal sensitive material insulation layers 18, 19, then wrapped with a layer of metal conductor 20, and then wrapped with 1-2 layers of outer sheath 14, 15. The synthesized temperature resistance effect is similar to FIG. 3A.

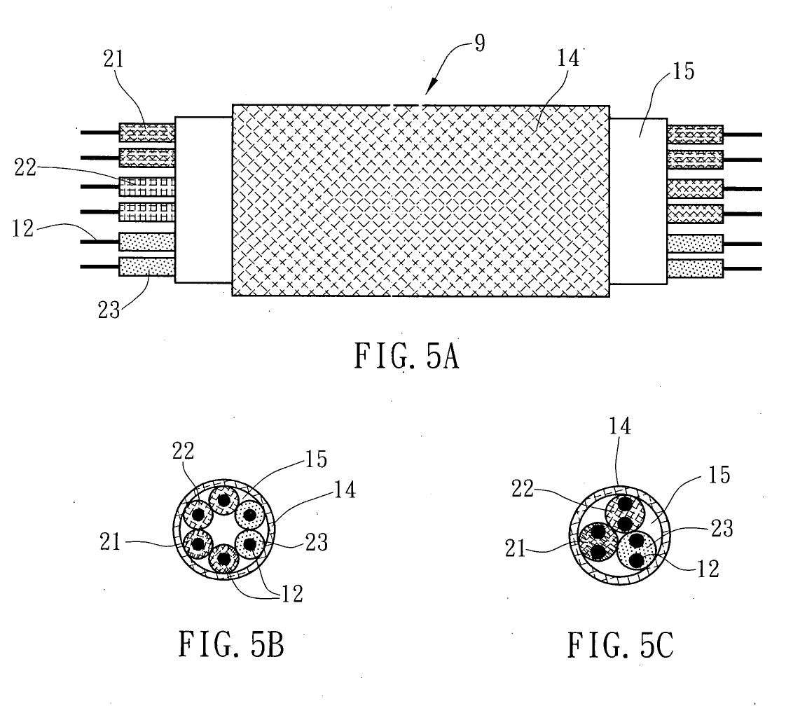

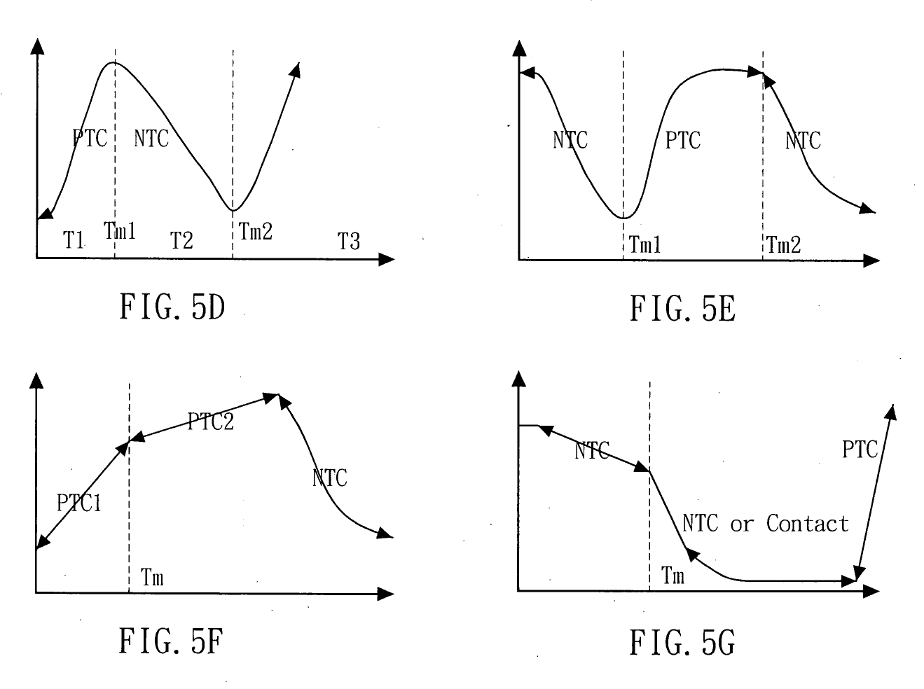

Referring to FIG. 5A, a sensing cable 9 in accordance with a fourth embodiment of the present invention is shown comprised of 6 metal conductors 12. Two by two are wrapped with different temperature resistance characteristic thermal sensitive material insulation layers 21, 22, 23. The wires are twisted or arranged in parallel, and then wrapped with 1˜2 layers of outer sheath 14, 15. The purposes are that 1. Capable of obtaining the characteristic parameters in the sectional temperature range, making the cable express different temperature characteristics in different temperature sections. This is to guarantee the production of low temperature alarm and differential temperature alarm (usually below 54° C.), and is capable of effectively adapting to environment temperature changing with high reliability as well. 2. Capable of deciding the synthesized effect threshold changing temperature Tm1, Tm2 of the 2 thermal sensitive characteristic cables and several temperature range ΔT1, ΔT2 so as to increase the flexibility of the detector so that the detector can take care of the low temperature alarm and high temperature alarm, simultaneously.

According to the selection methodology described above, the sensing cable can express the temperature resistance characteristics as shown in FIGS. 2D˜2G, FIGS. 3C˜3F, and FIGS. 5D˜5G.

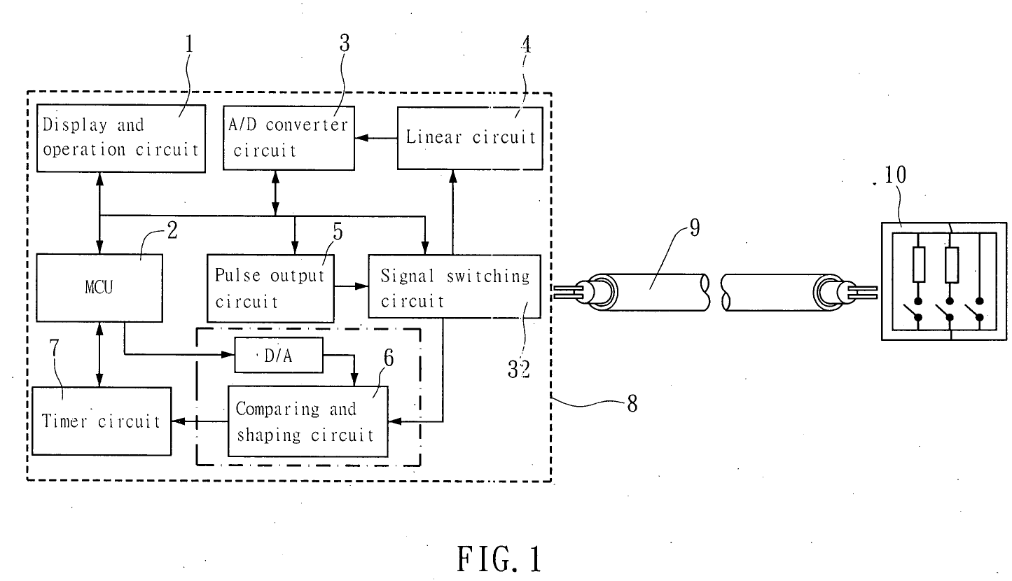

The composition of the sensing detector containing above described sensing cable is shown in FIG. 1. It is comprised of an interface unit 8, a sensing cable 9 corresponding to temperature resistance characteristic, and an EOL (cable terminal unit) 10. The sensing cable 9 is comprised of 2˜6 metal conductors, restorable insulation layer with different temperature resistance characteristic, and 1˜2 layers of outer sheath. Each metal conductor is wrapped by 1˜2 insulation layers, and are twisted together. These twisted conductors are wrapped by the outer sheath. The interface unit (temperature sensing interface) 8 is comprised of a signal amplifier and linear circuit 4, an A/D converter circuit 3, a MCU (microprocessor circuit) 2, a display and operation circuit (LCD display module) 1, a pulse output circuit 5, a comparing and shaping circuit 6, a timer circuit 7, and a signal switching circuit (multi-channel selector) 32.

Normally, the MCU (microprocessor circuit) 2 controls the signal switching circuit (multi-channel selector) 32 to connect the conductors of the sensing cable to the input of the signal amplifier and linear circuit 4. The signal is processed by the signal amplifier and linear circuit 4 and collected by the A/D converter circuit 3, and then sent to the MCU (microprocessor circuit) 2.

When temperature is found abnormal, the MCU (microprocessor circuit) 2 controls the signal switching circuit (multi-channel selector) 32 to operate such that the interface unit 8 is in the state of temperature abnormal point positioning and detection. Following the command from the MCU (microprocessor circuit) 2, the pulse output circuit 5 outputs a specific frequency or pulse width signal. The signal can be used for the phase difference detection of the reflection pulse. The comparing and shaping circuit 6 forms the phase difference signal by means of using a high speed comparator and the reference voltage outputted from the A/D converter circuit 3, and then outputs the phase difference signal to the timer circuit 7. The MCU (microprocessor circuit) 2 picks up the pulse number from the timer circuit 7 for calculation to obtain the phase difference T, and finally calculates the distance from the temperature abnormal point to the interface unit 8. In the mean time, the MCU (microprocessor circuit) 2 controls the actions of the output relay, display lamp and the display and operation circuit (LCD display module) 1 for necessary display.

The EOL (cable terminal unit) 10 is comprised of one or several resistors. The value of these resistors is matching to the resistance of the sensing cable. For those sensing cable greater than 2 metal conductors, the resistors can be omitted such that making it a conductor end terminal for connection to the metal conductors 12.

Although particular embodiments of the invention have been described in detail for purposes of illustration, various modifications and enhancements may be made without departing from the spirit and scope of the invention. Accordingly, the invention is not to be limited except as by the appended claims

What the invention claimed is:

1. A multi temperature resistance characteristic sensing cable comprising:
at least one twisted cable, said at least one twisted cable each comprising a plurality of metal conductors and at least one restorable insulation layer with different temperature resistance characteristic wrapped about each of said metal conductors; and
at least one sheath wrapped about said at least one twisted cable.

2. The multi temperature resistance characteristic sensing cable as claimed in claim 1, wherein said at least one restorable insulation layer are prepared from one of the materials including NTC (Negative Temperature Coefficient) thermal sensing materials, PTC (Positive Temperature Coefficient) thermal sensing materials, non-solvable “tunnel conduction effect” restorable materials, and solvable materials; said metal conductors are prepared from one of the materials including copper wires, stainless wires, thermocouple wires, and alloy resistance wires.

3. The multi temperature resistance characteristic sensing cable as claimed in claim 1, wherein said at least one restorable insulation layer with different temperature resistance characteristic are selectively prepared from different thermal sensing materials subject to required temperature response characteristics, providing one of the combination of resistance characteristics of first drop then rise, first rise then drop, and drop/rise with changing slope.

4. The multi temperature resistance characteristic sensing cable as claimed in claim 1, wherein said at least one restorable insulation layer is prepared from different temperature resistance characteristic thermal sensing materials that are selected to decide the threshold temperature and temperature range so as to realize the alarm in a predetermined temperature range.

5. The multi temperature resistance characteristic sensing cable as claimed in claim 2, wherein said NTC (Negative Temperature Coefficient) thermal sensing materials include high density polyethylene, ethylene vinyl acetate, conduction additive, anti-oxidant, and other additives.

6. The multi temperature resistance characteristic sensing cable as claimed in claim 2, wherein said PTC (Positive Temperature Coefficient) thermal sensing materials include (calculated as per 100% weight): 30˜60% PVDF polymer or copolymer, 10˜60% conduction additive, 0-30% crystal or semi-crystal polymer, and 0-30% of other additives.

7. The multi temperature resistance characteristic sensing cable as claimed in claim 2, wherein said non-solvable “tunnel conductor effect” restorable thermal sensing materials include (calculated as per 100% weight): 40˜60% of high density polyethylene, 10˜30% of ethylene vinyl acetate, 10˜25% of carbon black, and 10˜30% of zinc oxide.

8. The multi temperature resistance characteristic sensing cable as claimed in claim 2, wherein said non-solvable “tunnel conductor effect” restorable thermal sensing materials include (calculated as per 100% weight): 50˜80% of ethylene-tetrafluoroethylene, 0˜24% of vinylidene fluoride hexafluoro-propene, 0˜15% of carbon black, and 10˜20% of zinc oxide.

9. The multi temperature resistance characteristic sensing cable as claimed in claim 2, wherein said solvable material is selected from one of the materials including ethylene vinyl acetate, low density polyethylene), high density polyethylene, and solvable salt.

10. The multi temperature resistance characteristic sensing cable as claimed in claim 2, wherein the conductive temperature of said non-solvable “tunnel conductor effect” restorable thermal sensing materials and the cable are 50˜180° C.

11. A linear heat detector comprising:
an interface unit, said interface unit comprised of a signal amplifier and linear circuit, an A/D converter circuit, a microprocessor circuit, a display and operation circuit, a pulse output circuit, a comparing and shaping circuit, a timer circuit, and a signal switching circuit;
a sensing cable corresponding to temperature resistance characteristic, said sensing cable comprising at least one twisted cable, said at least one twisted cable each comprising a plurality of metal conductors and at least one restorable insulation layer with different temperature resistance characteristic wrapped about each of said metal conductors, and at least one sheath wrapped about said at least one twisted cable; and
a cable terminal unit,
wherein said microprocessor controls said signal switching circuit to connect the metal conductors of said sensing cable to an input end of said signal amplifier and linear circuit so that signal is processed by said signal amplifier and linear circuit and collected by said A/D converter circuit, and then sent to said microprocessor circuit; when temperature is abnormal, said microprocessor circuit controls said signal switching circuit to operate such that said interface unit is in the state of temperature abnormal point positioning and detection; said pulse output circuit outputs a specific frequency/pulse width signal subject to command from said microprocessor circuit so that the signal is used for phase difference detection of reflection pulse; said comparing and shaping circuit forms a phase difference signal by means of using a high speed comparator and a reference voltage outputted from said D/A converter, and then outputs the phase difference signal to said timer circuit; said microprocessor circuit picks up the pulse number from said timer circuit for calculation to obtain a phase difference, and finally calculates the distance from the temperature abnormal point to said interface unit so that said microprocessor circuit controls the actions of an output relay, a display lamp and said display and operation circuit for necessary display.
